(19) United States
(12) Patent Application Publication
(10) Pub. No.: US 2026/0155970 A1
(43) Pub. Date: Jun. 4, 2026

(54) Secure Orchestrator for Modular Access (SOMA) for Risk-Conditioned Identity Recovery and Cryptographic Key Rotation

(71) Applicant: SravanaKumar Nidamanooru, Huntersville, NC (US)

(72) Inventor: SravanaKumar Nidamanooru, Huntersville, NC (US)

(21) Appl. No.: 19/455,552

(22) Filed: Jan. 21, 2026

Related U.S. Application Data
(60) Provisional application No. 63/887,496, filed on Sep. 24, 2025.

(51) Int. Cl. H04L 9/08; G06F 21/40

(52) U.S. Cl. CPC H04L 9/0894; G06F 21/40

(57) ABSTRACT

Systems and methods are disclosed for orchestrating sensitive identity actions, including recovery, re-keying, and credential rotation, using risk-conditioned control selection and enforceable authorization gates. A gateway obtains contextual signals, computes a risk output, and selects a discrete policy band specifying required step-up verifications, a quorum threshold t, and a cryptographic profile. When quorum authorization is required, an escrow instance is initiated that stores required step-ups and threshold t, custodians are assigned, and approvals are accepted only from assigned custodians and only upon verifiable step-up satisfaction. Upon quorum satisfaction, the system releases a release value, performs crypto-agile re-keying under classical, hybrid, or post-quantum profiles, and optionally executes a dependency-aware rotation plan with validation and rollback. The system generates decision receipts and audit events binding inputs, policy outputs, approvals, escrow transitions, and resulting actions, with optional integrity protections enabling independent verification and tamper detection.

### 1. CROSS-REFERENCE TO RELATED APPLICATIONS

This application claims the benefit of U.S. Provisional Patent Application No. 63/887,496, filed Sep. 24, 2025, titled “Secure Orchestrator for Modular Access (SOMA): Risk Aware Recovery and Crypto Agile Credential Issuance,” the contents of which are incorporated herein by reference in their entirety.

### 2. FIELD

The present disclosure relates generally to identity and access management (IAM) and cybersecurity, and more particularly to systems and methods for risk-conditioned identity recovery, re-keying, and credential rotation using step-up verification, quorum-based approvals, escrowed release, crypto-agile key rollover, and verifiable decision receipts.

### 3. BACKGROUND

Recovery and credential reset workflows are commonly exploited even when primary authentication is strong. Attackers often succeed by abusing helpdesk resets, recovery email or SMS takeover, enrollment override flows, and other operational exceptions. In many organizations, a single administrator or support agent can complete a reset or re-enrollment with limited friction, creating a single point of failure and elevating insider risk.

Machine and workload identities also present security and operational challenges. Service accounts, API keys, certificates, and other non-human credentials are frequently long-lived and copied across systems. Rotation may be delayed due to fear of downtime, and when performed it can be brittle because dependencies are not coordinated and rollback is unclear.

Post-quantum cryptography (PQC) migration further increases complexity. Organizations may need to adopt classical, hybrid, and post-quantum profiles over time, while preventing unsafe downgrades and avoiding service disruption. At the same time, audit evidence for sensitive actions is often fragmented across systems and may not capture why an action was allowed, stepped up, quorum-gated, denied, or rolled back.

Accordingly, there exists a need for systems and methods that provide enforceable, risk-conditioned, and explainable control over sensitive identity actions, including recovery, re-keying, and rotation, while generating verifiable records suitable for security, compliance, and forensics.

### 4. SUMMARY

In general, the present disclosure provides systems and methods for orchestrating sensitive identity actions using risk-conditioned control selection and enforceable authorization gates. In some embodiments, the disclosed system is referred to as Secure Orchestrator for Modular Access (SOMA).

In some embodiments, a gateway or orchestrator receives a request to perform a sensitive identity action for a subject. The gateway obtains contextual signals associated with the request and generates, via a risk engine, a risk output comprising at least a normalized risk score. A policy engine maps the risk output to a discrete policy band that specifies control outputs including required step-up verification kinds, a quorum threshold value t, and a cryptographic profile selection. When the policy output indicates quorum authorization, the system initiates an escrow instance associated with the request, selects and assigns custodians, and enforces that approvals are accepted only from assigned custodians and only upon satisfaction of the required step-up verification. In some embodiments, when step-ups are required, the escrow/quorum engine persists the required step-up verification kinds for the escrow instance and rejects an approval submission unless a verification artifact indicating satisfaction of the required step-ups is received, wherein the verification artifact is bound to the escrow identifier and an expiry window.

Upon satisfaction of the quorum threshold t, the system performs a release operation to obtain a release value associated with the escrow instance and performs re-keying according to the cryptographic profile selection, including classical, hybrid, and post-quantum-only profiles in various embodiments. In some embodiments, the release value comprises a reconstructed secret, a release token, a cryptographic envelope containing key-wrapped material, or a value from which key material is deterministically derived. In some embodiments, the cryptographic re-key module outputs a key identifier or reference, and raw key material is not returned to the requester. In some embodiments, the system generates and stores decision receipts and audit events that bind at least risk outputs, policy outputs, verification results, approvals, escrow state transitions, and resulting cryptographic and rotation actions, with optional integrity protections enabling independent verification and tamper detection.

### 5. BRIEF DESCRIPTION OF THE DRAWINGS

FIG. 1 is a block diagram illustrating an example system implementing Secure Orchestrator for Modular Access (SOMA) (100).

FIG. 2 is a block diagram illustrating example placement of SOMA (200) within an enterprise identity stack (210).

FIG. 3 is a block diagram illustrating an example risk evaluation pipeline (300).

FIG. 4 is a block diagram illustrating an example policy mapping (400).

FIG. 5 is a block diagram illustrating an example step-up verification and approval gating flow (500).

FIG. 6 is a block diagram illustrating an example custodian selection and assignment flow (600).

FIG. 7 is a block diagram illustrating an example escrow lifecycle state machine (700).

FIG. 8 is a block diagram illustrating an example quorum approval and threshold release process (800).

FIG. 9 is a block diagram illustrating example crypto-agile re-key modes (900).

FIG. 10 is a block diagram illustrating an example workload and machine identity flow with attestation gating (1000).

FIG. 11 is a block diagram illustrating an example cascading rotation plan (1100).

FIG. 12 is a block diagram illustrating an example decision receipt schema (1200).

FIG. 13 is a block diagram illustrating an example audit query and receipt verification workflow (1300).

FIG. 14 is a block diagram illustrating an example end-to-end sequence for a recovery transaction (1400).

### 6. REFERENCE NUMERALS

The following list of reference numerals is provided for convenience. Like numerals refer to like elements throughout the drawings.

### Core System

100 SOMA system (overall)
101 Sources/Channels (overall grouping)
105 Network/API communication
110 Gateway/Orchestrator
120 Risk engine
130 Policy engine
140 Step-up verification module/service
150 Custodian registry
152 Custodian selector
154 Assignment store (escrow_id→custodian_id mapping)
160 Escrow/Quorum engine
170 Crypto re-key module
180 Rotation orchestrator
190 Audit+Decision receipts subsystem

### Clients/Enterprise Placement

102 Self-service recovery portal
104 Helpdesk tool
106 Admin/SecOps console
108 SecOps workflow channel
109 CI/CD or automation controller
200 SOMA placement (overall)
210 Enterprise identity systems (overall)
212 IdP/Federation
214 Directory
216 IGA
218 PAM
220 Apps/APIs
230 Secrets/key stores (KMS/HSM/Vault)

### Risk Pipeline

300 Risk evaluation pipeline (overall)
310 Request context bundle
311 Workload attestation attributes
312 Identity attributes
314 Device attributes
316 Network attributes
318 Behavioral attributes
319 Support-channel attributes
320 Preprocessing/normalization
330 Reliability estimator
340 Risk scoring model
350 Risk output
352 Reliability values map
354 Evidence sufficiency S
356 Context trust C

### Policy Mapping

400 Policy mapping (overall)
410 Policy inputs
420 Band decision
430 Band examples
440 Policy output (controls)

### Step-Up/Approvals

500 Step-up+approval gating (overall)
510 Custodian/approver
520 Mediated approval interface
530 Step-up verification service
550 Failure output

### Custodian Selection

600 Custodian selection/assignment (overall)
620 Selection constraints
630 Custodian registry DB
640 Selector module
650 Assignment store
660 Enforcement block
670 Audit record point

### Escrow Lifecycle

700 Escrow lifecycle (overall)
710 OPEN
720 APPROVED
730 RELEASED
740 CANCELED
750 EXPIRED
760 Lifecycle rules

### Threshold Release

800 Quorum approval+release (overall)
810 Escrow initiation
820 Secret sharing
830 Custodians submit approvals/shares
840 Quorum processing
850 Reconstruction
860 Release output
870 Failure conditions

### Crypto Re-Key

900 Crypto-agile re-key (overall)
910 Inputs to re-key
920 Re-key module
930 Mode selection (classical/hybrid/PQC-only)
940 Re-key output
950 Safety controls

### Workload Attestation

1000 Workload flow (overall)
1010 Workload request
1020 Gateway/orchestrator (workload path)
1030 Attestation verification
1040 Risk+policy decision
1050 Rotation orchestrator (workload path)
1060 Outputs
1070 Failure outcomes

### Cascading Rotation

1100 Cascading rotation plan (overall)
1120 Dependent systems
1130 Health check/validation
1140 Cutover
1150 Rollback
1160 End state

### Decision Receipt+Verification

1200 Decision receipt schema (overall)
1210 Row 1 block
1220 Row 2 block
1226 Signature/HMAC field
1228 Hash chain field
1230 Merkle checkpoint field
1232 Counterfactual outcomes
1300 Audit query+receipt verification workflow (overall)

### End-To-End

1400 End-to-end sequence (overall)
1410-1494 Steps as described (intake→receipt stored)

### 7. Detailed Description

### 7.1 Overview

The following detailed description describes example embodiments of the disclosure with reference to the accompanying drawings. The embodiments are provided to enable a person having ordinary skill in the art to make and use the disclosed subject matter, and are not intended to limit the scope of the claims. Variations, substitutions, and alternatives may be made without departing from the scope of the disclosure.

In the drawings and this description, a component may be shown with a core reference numeral and also with a figure-specific reference numeral for an example implementation instance, subcomponent, or functional block; such numerals refer to the same logical component unless the context indicates otherwise.

In some embodiments, Secure Orchestrator for Modular Access (SOMA) system (100) provides an orchestration layer for sensitive identity actions, including, without limitation: account recovery, credential reset, authenticator re-enrollment, device binding changes, privilege elevation, break-glass access, key rollover, certificate rotation, API token rotation, and rotation of machine or workload identity secrets.

In some embodiments, SOMA system (100) evaluates contextual signals associated with a request, produces a risk output (350) using a risk engine (120), and maps the risk output (350) to a discrete policy band decision (420) using a policy engine (130). In some embodiments, the

policy output (440) deterministically selects control requirements such as step-up verification kinds using a step-up verification module/service (140), a quorum threshold value t using an escrow/quorum engine (160), escrow conditions for release, and a cryptographic profile for re-keying using a crypto re-key module (170). In some embodiments, SOMA system (100) enforces that approvals are accepted only when required step-up verification has been satisfied and only from assigned custodians selected from a custodian registry (150) by a custodian selector (152) and recorded in an assignment store (154).

In some embodiments, SOMA system (100) generates and stores decision receipts using an audit and decision receipts subsystem (190) that bind inputs, risk outputs, policy outputs, verification outcomes, approvals, escrow state transitions, cryptographic actions, and rotation actions (180). The decision receipts may include integrity metadata to support independent verification and tamper detection.

### 7.2 Example Architecture and Deployment Placement

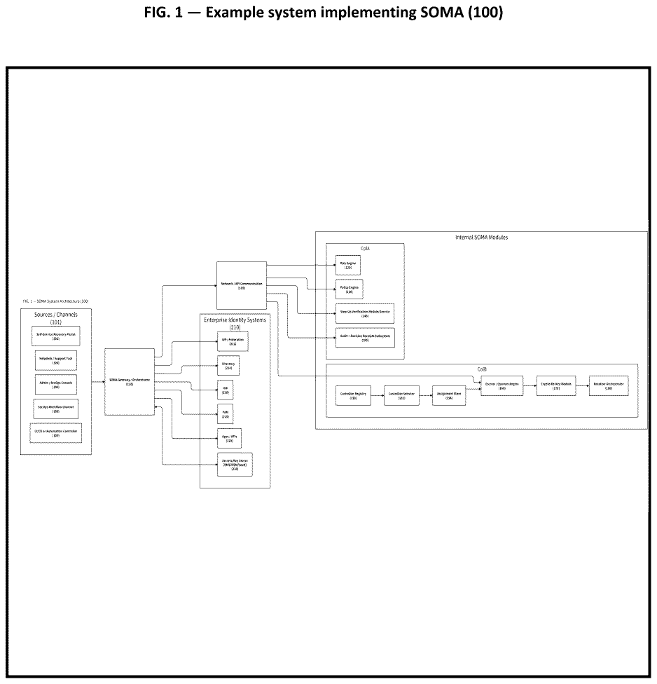

FIG. 1 illustrates an example system implementing SOMA (100). In some embodiments, the system includes a gateway/orchestrator (110), a risk engine (120), a policy engine (130), a step-up verification module (140), an escrow/quorum engine (160), a custodian registry (150) and selector (152), a cryptographic re-key module (170), a rotation orchestrator (180), and an audit and receipt subsystem (190). In some embodiments, one or more components communicate over a network via one or more APIs (105).

In some embodiments, the gateway/orchestrator (110) receives requests from clients/channels (101), including self-service recovery portals (102), helpdesk tools (104), administrative consoles (106), security operations workflows (108), CI/CD systems and automation controllers (109), and automated rotation controllers. The gateway/orchestrator (110) may normalize request data, apply abuse controls such as rate limiting, invoke risk scoring by the risk engine (120) and policy evaluation by the policy engine (130), initiate escrow instances in the escrow/quorum engine (160), coordinate custodian assignment and approvals using the custodian registry (150) and selector (152) and assignment store (154), invoke re-keying by the cryptographic re-key module (170) and optional rotation plans by the rotation orchestrator (180), and emit audit events and decision receipts via the audit and receipt subsystem (190).

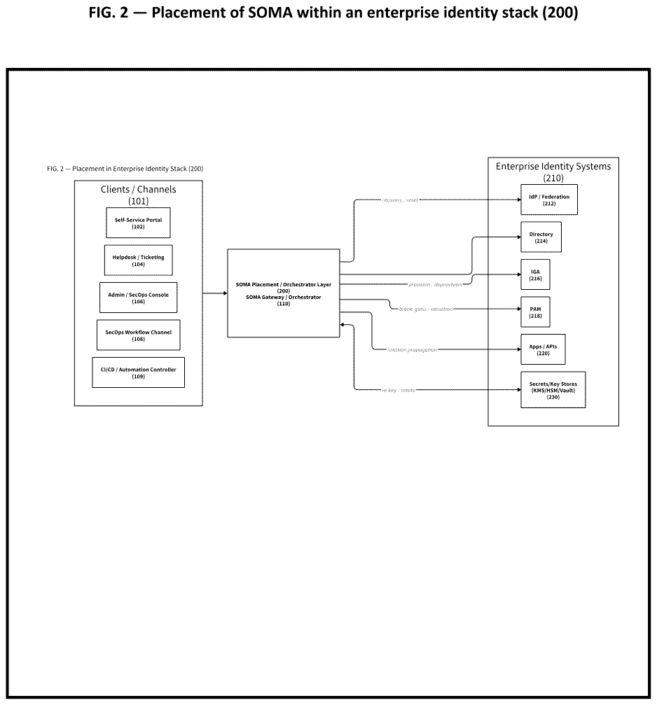

FIG. 2 illustrates an example placement of SOMA (200) within an enterprise identity stack (210). In some embodiments, SOMA (200) is positioned logically in front of one or more identity systems (210), including identity providers/federation (212), directories (214), identity governance tools (216), and privileged access tools (218), and mediates sensitive identity actions that otherwise would be performed directly through operational exception paths. In some embodiments, SOMA interfaces with applications/APIs (220) and secrets/key stores (230) for re-keying and rotation propagation.

### 7.3 Risk Engine, Evidence Builder, and Signals

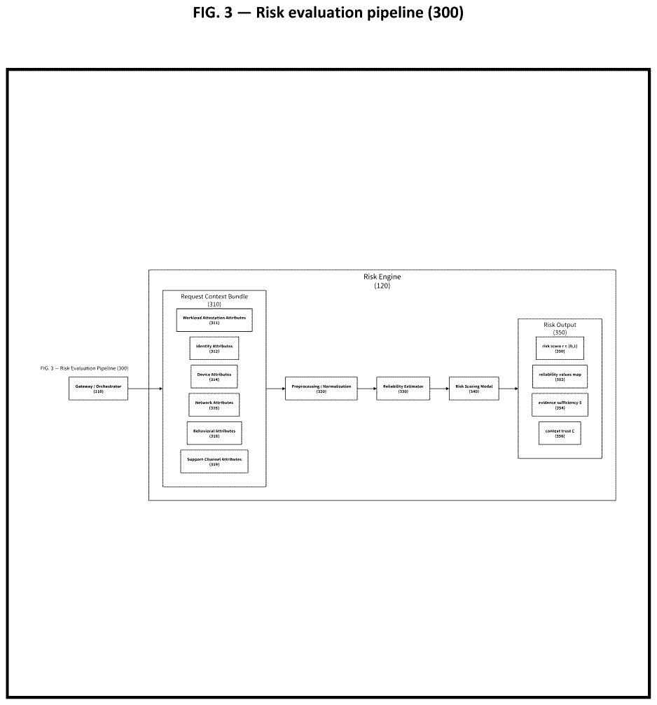

FIG. 3 illustrates an example risk evaluation pipeline (300). In some embodiments, the gateway/orchestrator (110) assembles a request context (310) for a sensitive identity action. The request context (310) may include identity attributes (312), device attributes (314), network attributes (316), behavioral attributes (318), support-channel attributes (319), and workload attestation attributes (311). In some embodiments, the request context (310) is normalized by a preprocessing stage (320) and may minimize sensitive fields.

In some embodiments, the risk engine (120) consumes the request context (310) and produces a risk output (350) including a normalized risk score r (for example, in a range [0, 1]). In some embodiments, the risk output (350) further includes per-signal reliability or confidence values (352) and may include an evidence sufficiency value S (354) and/or a context trust value C (356). In some embodiments, a reliability estimator (330) and/or a risk scoring model (340) are used to compute the risk output (350) and adjust outputs to account for missing, inconsistent, or low-integrity signals.

### 7.4 Policy Bands and Dynamic Quorum Derivation

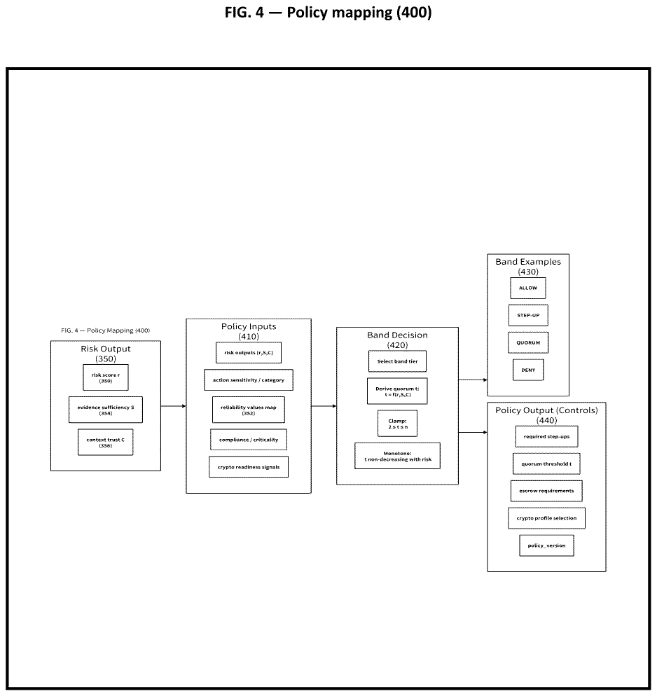

FIG. 4 illustrates an example policy mapping (400). In some embodiments, the policy engine (130) maps risk outputs (350) and policy inputs (410) to a discrete policy band decision (420). Example policy bands (430) include allow, step-up, quorum, and deny. The policy engine (130) further outputs control parameters as a policy output (440) including required step-up verification kinds, a quorum threshold value t, escrow requirements, and a cryptographic profile selection.

In some embodiments, the policy engine (130) derives the quorum threshold value t as a function of one or more inputs including risk score r (350), evidence sufficiency S (354), and context trust C (356). In some embodiments, t is constrained to a safe range (for example, 2≤t≤n) and may be clamped to prevent invalid thresholds. In some embodiments, monotonicity constraints are enforced such that t is non-decreasing as risk increases.

### 7.5 Step-Up Verification and Approval Gating

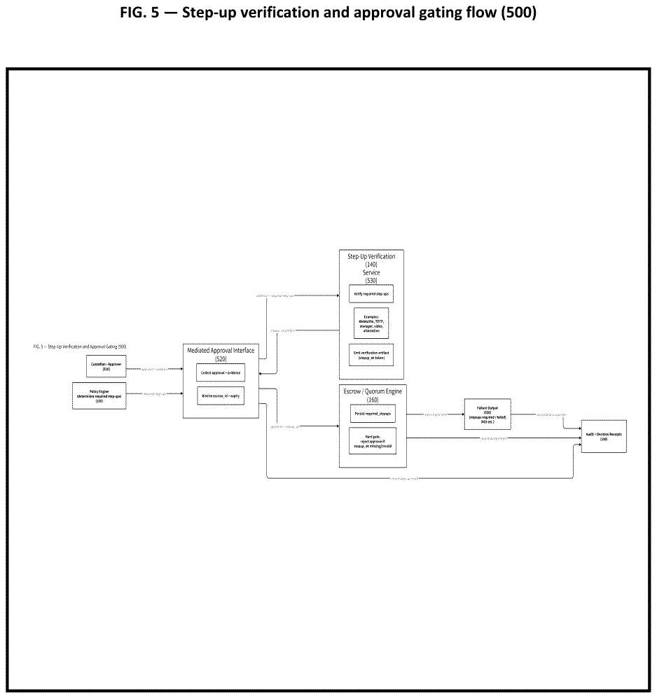

FIG. 5 illustrates an example step-up verification flow (500). In FIG. 5, the step-up verification module (140) is shown as a step-up verification service (530), and the approval path includes the custodian/approver (510), mediated approval interface (520), and failure output (550). In some embodiments, a custodian/approver (510) submits an approval via a mediated approval interface (520). The step-up verification module (140) or step-up verification service (530) verifies additional verification requirements determined by the policy engine (130) prior to authorization of a sensitive identity action. Example step-up kinds include WebAuthn assertions, TOTP, manager approval, video verification, and attestation.

In some embodiments, step-up verification is enforced as a hard gate for approvals. When step-ups are required for an escrow instance, the escrow/quorum engine (160) persists the required step-up kinds and rejects approvals that do not include a verifiable indication that the required step-ups were satisfied. In some embodiments, the mediated approval interface (520) verifies step-up evidence and forwards approvals together with a step-up satisfaction indicator or verification artifact bound to an escrow identifier and an expiry window to the escrow/quorum engine (160). Failure outcomes may be returned via a failure output (550), and outcomes are recorded in the audit and receipt subsystem (190).

### 7.6 Custodian Registry, Selection, and Assignment

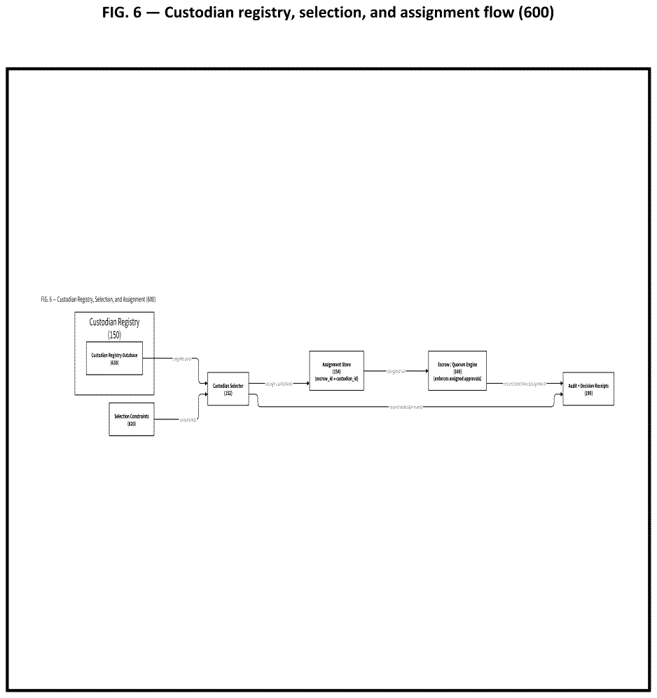

FIG. 6 illustrates an example custodian registry and selection flow (600). In FIG. 6, the custodian selector (152) is shown as a selector module (640), the assignment store (154) is shown as an assignment store implementation (650), and enforcement block (660) and audit record point (670) depict example enforcement and audit logic within the escrow/quorum engine (160) and audit and receipt subsystem (190), respectively. In some embodiments, the system includes a custodian registry (150) stored in a custodian registry database (630) that stores records for custodians eligible to approve sensitive identity actions. Custodian records may include identifiers, eligibility attributes, and capability attributes describing supported step-up methods.

In some embodiments, upon determining that a request requires quorum authorization, the system applies selection constraints (620) and selects custodians using a custodian selector (152/640). The selected custodians are explicitly assigned and stored as an assignment mapping in an assignment store (154/650) associated with an escrow identifier. Approvals from non-assigned custodians are rejected by the escrow/quorum engine (160), including enforcement logic (660). Selection and assignment events are recorded by the audit and receipt subsystem (190), including an audit record point (670).

### 7.7 Escrow Lifecycle and State Machine

In some embodiments, when a sensitive identity action requires quorum authorization, the gateway/orchestrator (110) initiates an escrow instance in the escrow/quorum engine (160). The escrow instance may include a subject identifier, action type, creation and expiry timestamps, required step-up kinds, assigned custodians, quorum threshold t, and one or more policy identifiers.

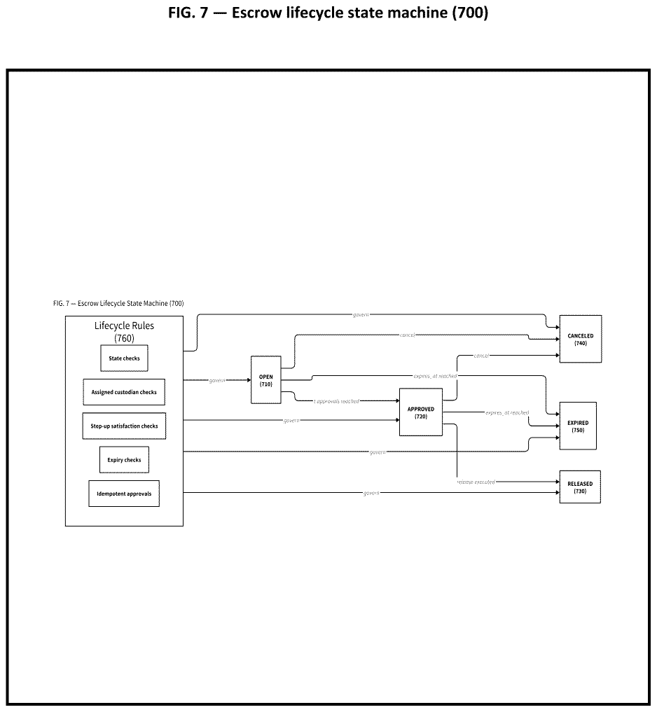

FIG. 7 illustrates an example escrow lifecycle state machine (700). In some embodiments, an escrow instance transitions through states including OPEN (710), APPROVED (720), RELEASED (730), EXPIRED (750), and CANCELED (740). Enforcement checks may include state checks, assigned custodian checks, step-up satisfaction checks, and expiry checks. In some embodiments, lifecycle rules (760) govern idempotent approvals and release conditions.

### 7.8 Quorum Approvals and Threshold Release

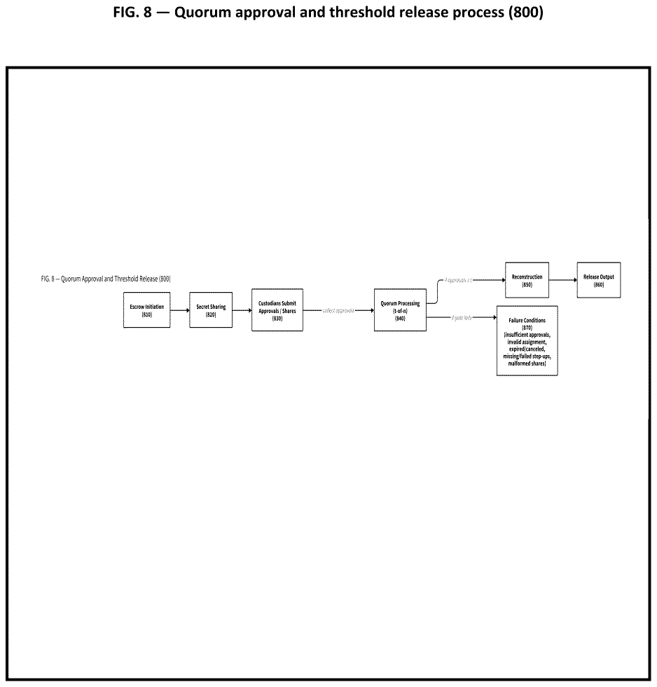

FIG. 8 illustrates an example quorum approval and threshold release process (800). In some embodiments, escrow initiation (810) leads to a secret sharing stage (820) and custodians submit approvals/shares (830) to an escrow/quorum engine (160) for quorum processing (840). The system authorizes the sensitive identity action only when approvals from at least t custodians out of a set of n custodians are recorded, after which reconstruction (850) and release output (860) occur. Failure conditions (870) may include insufficient approvals, invalid assignment, expired/canceled state, missing/failed step-ups, or malformed share submissions.

### 7.9 Crypto-Agile Re-Keying and Downgrade Protection

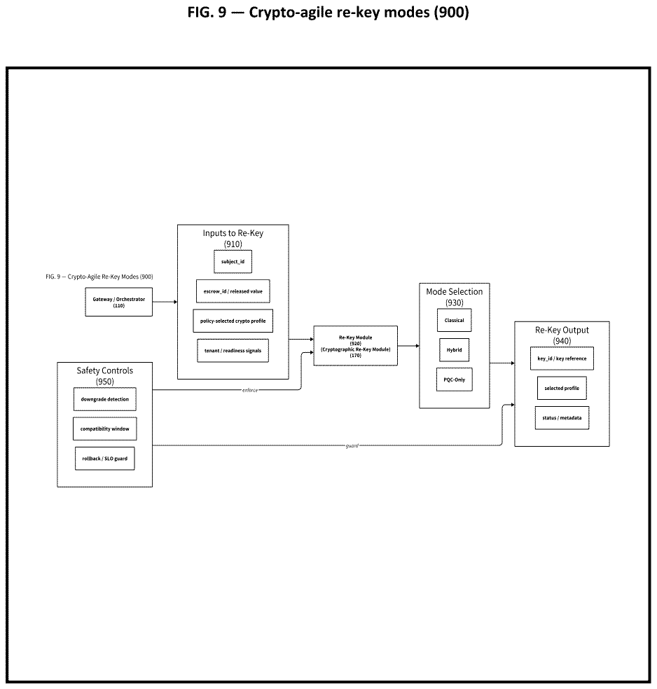

FIG. 9 illustrates example crypto-agile re-key modes (900). In FIG. 9, the cryptographic re-key module (170) is shown as a re-key module (920) operating on inputs to re-key (910) under a selected mode (930) to produce a re-key output (940) subject to safety controls (950). In some embodiments, after quorum satisfaction and escrow release, the gateway/orchestrator (110) invokes the cryptographic re-key module (170/920) using inputs to re-key (910) and a selected mode (930) to generate, derive, or provision new key material for the subject. The crypto module outputs a re-key output (940) including a key identifier or reference rather than raw key material. Optional safety controls (950) may include downgrade detection, compatibility windows, and rollback/SLO guards.

### 7.10 Workload and Machine Identity Handling With Attestation Gating

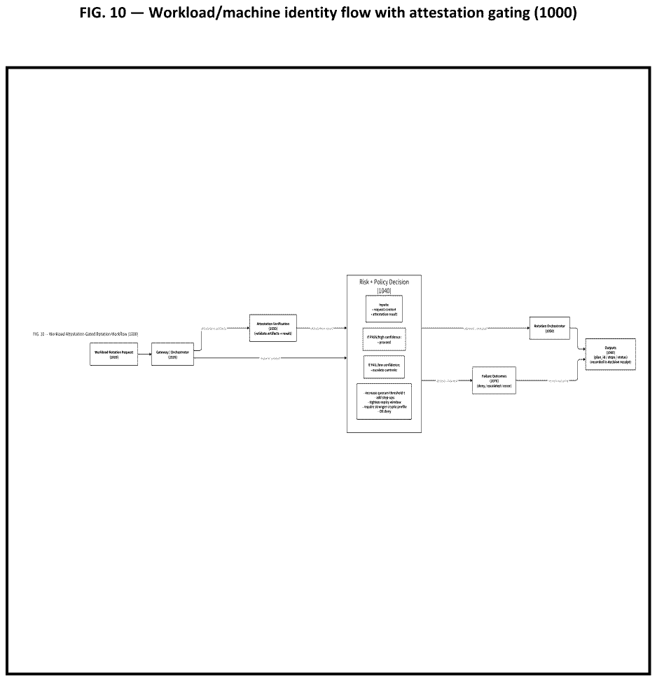

FIG. 10 illustrates an example workflow for a workload or machine identity (1000). In FIG. 10, the gateway/orchestrator (110) is shown as a workload-handling path (1020), the risk and policy decision component (1040) corresponds to processing by the risk engine (120) and policy engine (130), and the rotation orchestrator (180) is shown as a workload rotation path (1050). In some embodiments, a workload rotation request (1010) is received by the gateway/orchestrator (110), shown in FIG. 10 as workload-handling path (1020). The request includes attestation artifacts, which are validated by an attestation verification component (1030) to produce an attestation result. In some embodiments, the gateway/orchestrator (1020) provides the attestation result to a risk and policy decision component (1040). Failure or low-confidence attestation may cause escalation or denial via failure outcomes (1070). In some embodiments, rotation orchestration is performed by the rotation orchestrator (180), shown in FIG. 10 as workload rotation path (1050) and results are emitted as outputs (1060) and recorded in a decision receipt.

### 7.11 Cascading Rotation Orchestrator and Dependency Plans

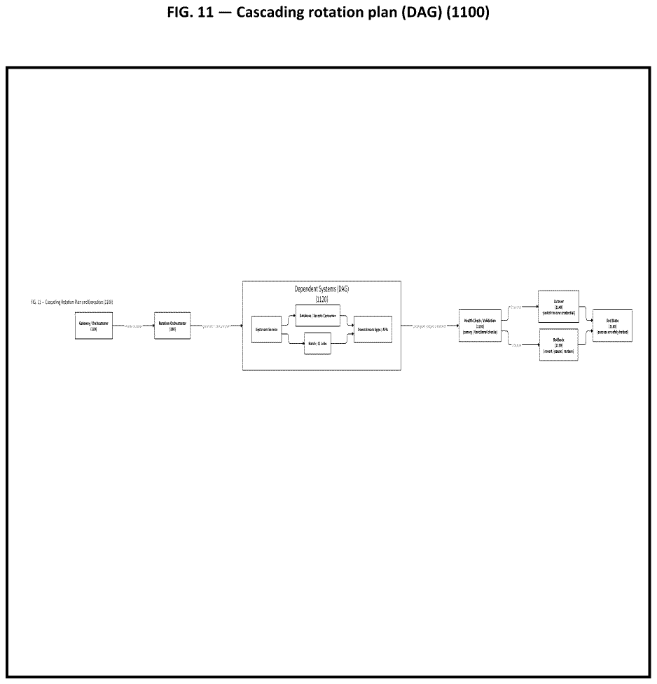

FIG. 11 illustrates an example cascading rotation plan (1100). In some embodiments, after re-keying, the gateway/orchestrator (110) invokes a rotation orchestrator to generate a dependency-aware plan across dependent systems (1120), perform validation (1130), execute cutover (1140), and optionally perform rollback (1150) before reaching an end state (1160). Outcomes are recorded via the audit and receipt subsystem (190) and bound into the decision receipt.

### 7.12 Decision Receipts, Audit, Integrity, and Verification

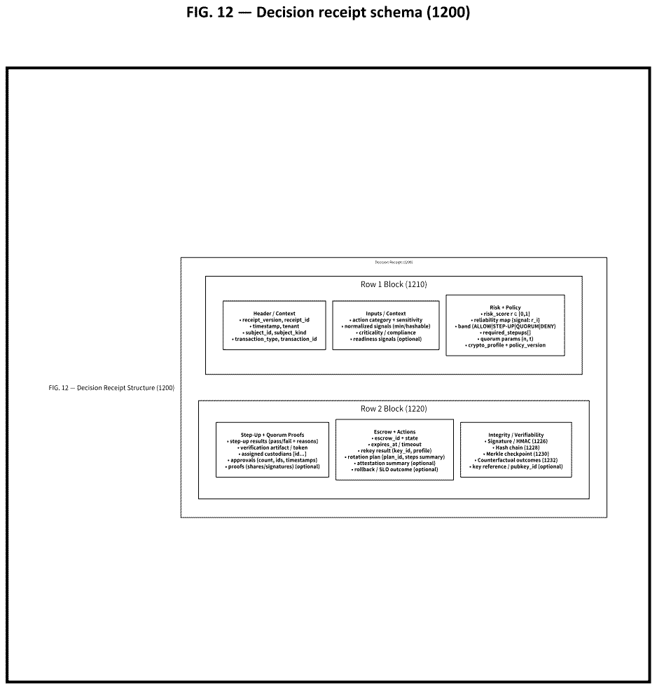

FIG. 12 illustrates an example decision receipt structure (1200). In some embodiments, the audit and receipt subsystem (190) stores queryable audit events and structured decision receipts (1200) that bind together decision-making inputs and outputs for a sensitive identity action. In some embodiments, the decision receipt includes a first row block (1210) containing header/context/decision elements and a second row block (1220) containing proofs/actions/integrity elements.

In some embodiments, decision receipts include integrity metadata enabling tamper detection and independent verification. Example integrity protections include a signature or HMAC field (1226), hash chaining fields (1228), Merkle checkpoint fields (1230), and optional counterfactual outcomes (1232).

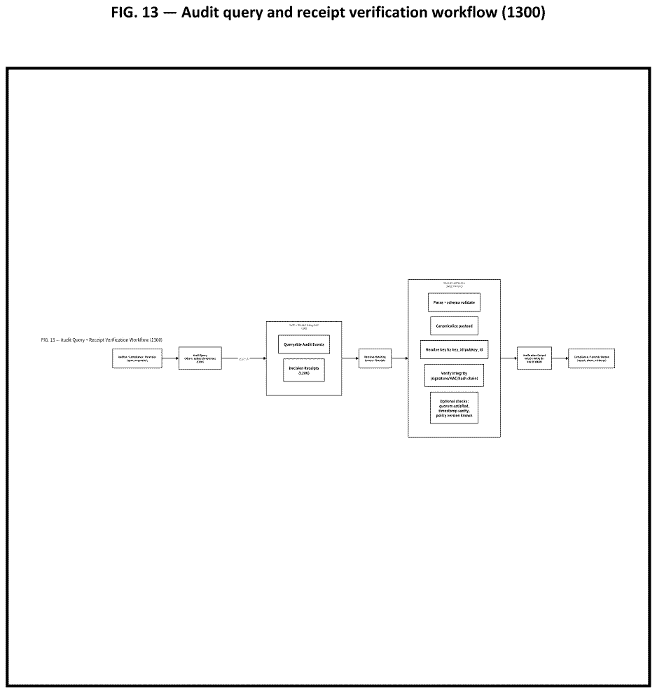

In some embodiments, a verifier validates a decision receipt using a deterministic procedure. FIG. 13 illustrates an example audit query and receipt verification workflow (1300).

### 7.13 End-To-End Recovery Sequence

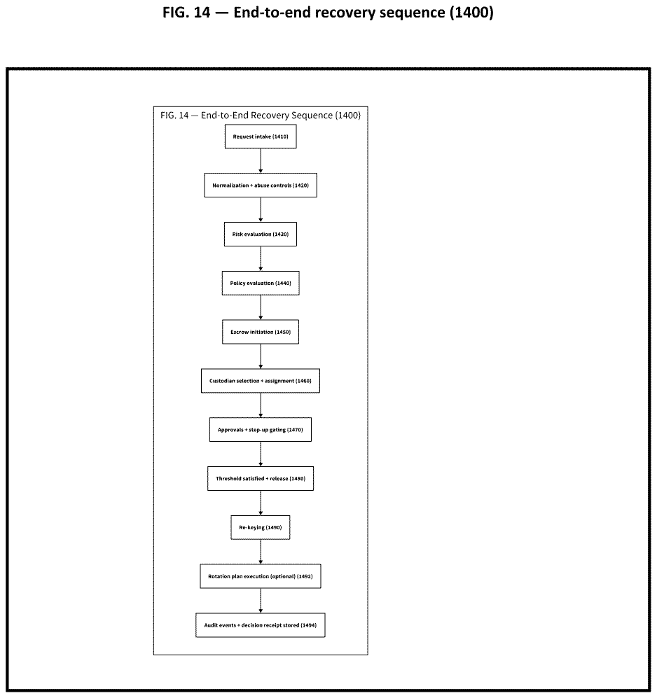

FIG. 14 illustrates an example end-to-end sequence for a recovery transaction (1400) including request intake (1410); normalization and abuse controls (1420); risk evaluation (1430); policy evaluation (1440); escrow initiation when quorum is required (1450); custodian selection and assignment (1460); approvals with step-up gating (1470); threshold satisfaction and release (1480); re-keying (1490); optional rotation plan execution (1492); and storage of audit events and a decision receipt (1494).

### 7.14 Definitions and Terminology

As used herein, the following terms have the meanings described below unless the context indicates otherwise.

Subject refers to an identity whose credentials, authenticators, or secrets are the target of an action, including a human user identity or a workload/machine identity.

Sensitive identity action refers to an action including account recovery, credential reset, authenticator enrollment/re-enrollment, break-glass access, re-keying, key rollover, certificate rotation, API token rotation, or secrets rotation.

Request identifier (RID) refers to an identifier associated with a transaction or request instance.

Escrow identifier refers to an identifier associated with an escrow instance created for a transaction.

Risk score (r) refers to a normalized value representing likelihood of compromise or fraud associated with a request.

Evidence sufficiency (S) refers to a value indicating whether sufficient trustworthy evidence is available to support a decision for the requested action.

Context trust (C) refers to a baseline trust value for a session, channel, or workflow context.

Policy band refers to a discrete decision tier (e.g., allow, step-up, quorum, deny) produced by the policy engine.

Step-up verification refers to one or more additional verification requirements beyond baseline authentication (e.g., WebAuthn, TOTP, manager approval, video verification, attestation).

Custodian refers to an assigned approver eligible to provide an approval for a transaction subject to policy requirements.

Quorum threshold (t-of-n) refers to a threshold number t of approvals required from a set of n custodians.

Crypto profile refers to a cryptographic mode selection including classical, hybrid, or post-quantum-only profiles for re-keying.

Decision receipt refers to a structured record that binds inputs, risk outputs, policy outputs, verification outcomes, approvals, escrow transitions, and resulting actions, optionally with integrity protections.

Verification artifact refers to a token, signature, MAC, or other verifiable indicator that a required verification (e.g., step-up) has been satisfied and is bound to a transaction identifier and validity constraints.

Rotation plan refers to a sequence or dependency graph of steps for propagating updated credentials across dependent systems safely.

1. A system comprising one or more processors and memory storing instructions that, when executed, cause the system to:
(a) receive, at a gateway or orchestrator, a request to perform a sensitive identity action for a subject;
(b) obtain contextual signals associated with the request;
(c) generate, using a risk engine, a risk output comprising at least a normalized risk score;
(d) determine, using a policy engine, a policy band decision and control outputs comprising (i) one or more required step-up verification kinds, (ii) a quorum threshold value t, and (iii) a cryptographic profile selection;
(e) initiate an escrow instance associated with the request responsive to the policy band decision indicating quorum authorization, the escrow instance including the quorum threshold value t and the one or more required step-up verification kinds;
(f) select and assign a set of custodians for the escrow instance and store an assignment mapping associating the escrow instance with identifiers of the assigned custodians;
(g) accept approvals for the escrow instance only when (i) an approving custodian is included in the assignment mapping and (ii) a step-up verification requirement for the escrow instance is satisfied;
(h) determine that quorum is satisfied when a number of valid approvals meets the quorum threshold value t;
(i) perform a release operation responsive to quorum satisfaction to obtain a release value associated with the escrow instance;
(j) perform a re-key operation for the subject according to the cryptographic profile selection; and
(k) generate and store a decision receipt that binds at least the risk output, the policy band decision, step-up verification outcomes, approvals, escrow state transitions, and the re-key operation.

2. The system of claim 1, wherein the policy engine derives the quorum threshold value t as a function of at least the normalized risk score r, an evidence sufficiency value S, and a context trust value C.

3. The system of claim 2, wherein the policy engine constrains the quorum threshold value t to be non-decreasing as the normalized risk score increases.

4. The system of claim 1, wherein the escrow instance persists the one or more required step-up verification kinds and rejects an approval submission that lacks a verification artifact indicating satisfaction of the one or more required step-up verification kinds.

5. The system of claim 4, wherein the verification artifact is bound to at least an escrow identifier and an expiry time window.

6. The system of claim 1, further comprising a mediated approval interface in which the gateway or orchestrator verifies step-up evidence and forwards an approval to an escrow/quorum engine together with a step-up satisfied indicator.

7. The system of claim 1, wherein selecting and assigning the set of custodians is performed using a custodian registry storing custodian records with attributes, and wherein the selection enforces at least one diversity constraint across an attribute class.

8. The system of claim 7, wherein the diversity constraint comprises separation across at least one of organizational unit, geographic region, or management chain.

9. The system of claim 1, wherein the escrow instance implements a threshold secret sharing scheme that splits a secret into n shares such that any t shares reconstruct the secret.

10. The system of claim 1, wherein the cryptographic profile selection comprises at least one of a classical profile, a hybrid profile, or a post-quantum-only profile, and wherein the system rejects an attempted downgrade to a weaker profile when a minimum profile strength is required by policy.

11. A method comprising:
(a) receiving a request to perform a sensitive identity action for a subject;
(b) computing, using contextual signals, a risk output for the request;
(c) selecting, using a policy engine, a policy band decision that specifies (i) one or more required step-up verifications, (ii) a quorum threshold t, and (iii) a cryptographic profile;
(d) responsive to the policy band decision indicating quorum authorization, initiating an escrow instance associated with the request, the escrow instance storing the quorum threshold t and the one or more required step-up verifications;
(e) assigning a set of custodians to the escrow instance and rejecting approvals from non-assigned custodians;
(f) accepting an approval for the escrow instance only upon receipt of a verifiable indication that the one or more required step-up verifications were satisfied;
(g) releasing a release value responsive to satisfaction of the quorum threshold t;
(h) re-keying the subject according to the cryptographic profile; and
(i) generating and storing a decision receipt binding at least the risk output, the policy band decision, approvals, and results of releasing and re-keying.

12. The method of claim 11, wherein selecting the policy band decision comprises deriving the quorum threshold t as a function of at least a risk score r, an evidence sufficiency value S, and a context trust value C, and clamping t to a safe range relative to an approval set size n.

13. The method of claim 11, wherein the verifiable indication comprises a verification artifact bound to at least an escrow identifier and an expiry window, and wherein the escrow instance rejects an approval submission that lacks the verification artifact when step-up verifications are required.

14. The method of claim 11, wherein assigning the set of custodians comprises selecting custodians from a custodian registry using at least one diversity constraint across an attribute class and applying an exclusion list.

15. The method of claim 11, further comprising identifying the subject as a workload or machine identity, verifying one or more attestation artifacts, and escalating controls responsive to failed or missing attestation by at least one of increasing the quorum threshold t, adding step-up verifications, constraining the cryptographic profile, or denying the request.

16. The method of claim 11, further comprising generating a rotation plan for propagating updated credentials across dependent systems, executing at least a portion of the rotation plan using validation checks, and performing a rollback operation responsive to a detected failure condition.

17. The method of claim 11, wherein the decision receipt includes integrity metadata comprising at least one of a signature, a message authentication code, a hash-chain link to a prior receipt, or a Merkle checkpoint, and wherein the decision receipt further includes at least one counterfactual policy outcome computed by replaying policy evaluation using a modified input.

18. A non-transitory computer-readable medium storing instructions that, when executed by one or more processors, cause performance of operations comprising:
(a) receiving a request to perform a sensitive identity action for a subject;
(b) computing, using contextual signals, a risk output for the request;
(c) selecting, using a policy engine, a policy band decision that specifies one or more required step-up verifications, a quorum threshold t, and a cryptographic profile;
(d) initiating an escrow instance associated with the request, the escrow instance storing the quorum threshold t and the one or more required step-up verifications;
(e) assigning a set of custodians to the escrow instance and rejecting approvals from non-assigned custodians;
(f) accepting an approval only upon receipt of a verifiable indication that the one or more required step-up verifications were satisfied;
(g) releasing a release value responsive to satisfaction of the quorum threshold t;
(h) re-keying according to the cryptographic profile; and
(i) generating and storing a decision receipt binding at least the risk output, the policy band decision, approvals, and results of releasing and re-keying.

19. The computer-readable medium of claim 18, wherein the operations further comprise verifying integrity of the decision receipt by: (i) parsing and schema-validating the decision receipt, (ii) canonicalizing a receipt payload using deterministic canonicalization, (iii) resolving a verification key using a key identifier in the decision receipt, and (iv) verifying a signature or a message authentication code over the canonicalized payload.

20. The computer-readable medium of claim 18, wherein the operations further comprise providing an audit query interface that retrieves decision receipts by at least one of subject identifier, transaction type, time range, policy version, crypto profile, escrow identifier, or custodian identifier, and returning a verification status for each retrieved decision receipt.
